(19) United States
(12) Patent Application Publication
(10) Pub. No.: US 2025/0285042 A1
(43) Pub. Date: Sep. 11, 2025

(54) METHOD AND SYSTEM FOR ADAPTIVELY DEVISING ROUTE BETWEEN TARGET PICKUP LOCATION AND TARGET DESTINATION LOCATION

(71) Applicant: GRABTAXI HOLDINGS PTE. LTD., Singapore (SG)

(72) Inventors: Yibo JI, Singapore (SG); Larry Junjie LIN, Singapore (SG)

(21) Appl. No.: 19/067,032

(22) Filed: Feb. 28, 2025

(30) Foreign Application Priority Data
Mar. 8, 2024 (SG) 10202400654P

(51) Int. Cl. G06Q 10/047

(52) U.S. Cl. CPC G06Q 10/047

(57) ABSTRACT

The present disclosure relates generally to a method and system for adaptively devising a route from target pickup location to target destination location. According to a first aspect, the present disclosure refers to a method of adaptively devising a route from a target pickup location to a target destination location, the target pickup location and target destination location indicated in a request, comprising: comparing, by a processor, a distance between the target pickup location and a pickup location indicated in a previously received request to determine if the distance is below a first threshold value; and determining, by the processor, whether or not to devise the route from the target pickup location to the target destination location in response to the comparison.

### CROSS REFERENCE

The present invention application is a non-provisional U.S. patent application claiming priority to Singapore patent application Ser. No. 10/202,400654P, which was filed on Mar. 8, 2024, the content of which is incorporated by reference herein in its entirety.

### TECHNICAL FIELD

The present disclosure relates generally to a method and a system for adaptively devising a route between target pickup location and target destination location.

### BACKGROUND

The Vehicle Routing Problem (VRP) is a critical and extensively researched issue in the domains of transportation and logistics. It involves the optimization of routes for vehicles tasked with the delivery and pickup of goods or passengers, aiming to minimize the total operational cost. Traditional methods for solving VRP rely on optimization techniques and exact algorithms. However, these approaches encounter significant combinatorial challenges as the number of variables (such as locations) increases, leading to exponential growth in computational complexity. Consequently, exact algorithms, while precise, become computationally intensive and impractical for large-scale, real-world applications.

A need therefore exists to provide a method, system and server for adaptively devising a route between a target pickup location and a target destination location to solve the above issues, for example, by reducing the combinational complexity of the algorithms.

Furthermore, other desirable features and characteristics will become apparent from the subsequent detailed description and the appended claims, taken in conjunction with the accompanying drawings and this background of the disclosure.

### SUMMARY

In a first aspect, the present disclosure refers to a method of adaptively devising a route from a target pickup location to a target destination location, the target pickup location and target destination location indicated in a request, comprising, comparing, by a processor, a first distance between the target pickup location and a pickup location indicated in a previously received request to determine if the first distance is below a first threshold value, and determining, by the processor, whether or not to devise the route from the target pickup location to the target destination location in response to the comparison.

In a second aspect, the present disclosure refers to a system for adaptively devising a route from a target pickup location to a target destination location, the target pickup location and target destination location indicated in a request, comprising, at least one processor, and at least one memory including computer program code, wherein the at least one memory and the computer program code configured to, with the at least one processor, cause the system at least to, compare a first distance between the target pickup location and a pickup location indicated in a previously received request to determine if the first distance is below a first threshold value, and determine whether or not to devise the route from the target pickup location to the target destination location in response to the comparison.

### BRIEF DESCRIPTION OF DRAWINGS

Some aspects of at least one embodiment of the present disclosure will now be described with reference to the drawings and appendices, in which:

FIG. 1 shows a block diagram illustrating a system for adaptively devising a route from a target pickup location to a target destination location according to various embodiments of the present disclosure.

FIG. 2 shows a graph network of points connected by routes among locations according to an embodiment of the present disclosure.

FIG. 3 shows a flow chart illustrating a method for devising a route to a location according to an embodiment of the present disclosure.

FIG. 4 shows a geographical map comprising locations related to three different requests according to an embodiment of the present disclosure.

FIG. 5 shows a code snippet executable in a programming language according to an embodiment of the present disclosure.

FIGS. 6A to 6F each shows a schematic diagram illustrating a different permutation of a route between locations associated with two requests according to an embodiment of the present disclosure.

FIGS. 7A and 7B show a block diagram of a general-purpose computer system upon which the route devising server of FIG. 1 can be practised.

FIG. 7C shows a block diagram of a general-purpose computer system upon which the travel co-ordination server of FIG. 1 can be practised.

FIG. 7D shows a block diagram of a general-purpose computer system upon which a combined travel co-ordination server and route devising server of FIG. 1 can be practised.

FIG. 8 shows an example of a computing device to realize the route devising server shown in FIG. 1.

FIG. 9 shows an example of a computing device to realize the travel co-ordination server shown in FIG. 1.

FIG. 10 shows an example of a computing device to realize a combined travel co-ordination and route devising server shown in FIG. 1.

### TERMS DESCRIPTION

Request—The term “request” can be understood as a request for a transportation of purchased goods, food, people or items. Each request comprises data relating to a pickup location and a destination location (e.g., geographical data such as latitude and longitude data). The pickup location refers to a location where people (or goods, food, items) can be picked up and the destination location refers to a location where the people (or goods, food, items) can be dropped off. In an embodiment, the destination location associated with the pickup location in a request may also be understood to be a location along the route from the initial pickup to final drop off location corresponding to the pickup location and destination location in another request. The data (user details, locations, services/goods purchased) related to the request may be processed by a server for adaptively devising a route from the pickup location to the destination location related to the request(s). In the present disclosure, when multiple requests (a request and a previously received request) are received, a route(s) which connects the locations indicated in the multiple requests are devised to form a network of possible routes (or graph network). The network of routes is then used to derive the optimal solution for example finding a best route (e.g., in terms of cost, distance and/or time) that connects all pickup locations to all destination locations to meet the multiple requests in a single trip. An optimal solution refers to a route for vehicles to pick up and deliver purchased goods, food, item and customers in an efficient manner. For example, a route may be considered an optimal solution if there are multiple pickups and drop offs in a single route. The optimal solution may also comprise of at least two locations connected in way that allows a provider (driver) to travel from a pickup location to a destination location of a request in the shortest way possible. The devised optimal solution will be further analysed by a server. This results in accelerating the computation of routes for the purpose of matching an appropriate provider (e.g., driver) to a requestor (e.g., user).

Previously received request—The term “previously received request” can be understood as a request for transportation of purchased goods, food, people or items that was received previously by a server. It can be understood as a request that is different from the request for the transportation of purchased goods, food, people or items as described above, and may comprise different data relating to a different pickup location and/or a different destination location. Similarly, the pickup location of such previously received request also refers to a location where people (or goods, food, items) can be picked up and its destination location refers to a location where the people (or goods, food, items) can be dropped off. The data (user details, locations, services/goods purchased) related to the previously received request may be processed by the server for adaptively devising a route from the pickup to destination locations related to the previously received request.

Location—A location may refer to a pickup or a destination location relating to a request. The pickup location of a request may represent a specific location where purchased goods, parcels, food or people can be picked up. The destination location of a request may represent a location where the purchased goods, parcels, food or people can be dropped off. For example, a pickup location could be where a user expects a ride service to pick him up, while a destination location is where the user intends to go. In various embodiments below, when the terms “target pickup location” and “pickup location” are used simultaneous in the description, they may refer to two different pickup locations associated with two different requests (e.g., first request and second, previously received request), respectively, and the terms “target destination location” and “destination location” are construed accordingly.

A location can be represented by geographical data, such as latitude and longitude coordinates. The location can also be represented by a geographical area around the latitude and longitude coordinates. When a server receives a request for a delivery service, the server processes the request, including the geographical data of a pickup location and a destination location relating to the delivery request. Additionally, the server may utilize the geographical data of the pickup location and destination location to devise an optimal solution connecting the pickup location and the destination location.

Route—The term “route” herein is used to indicate a path from one location to another location. The locations may refer to pickup locations or destination locations associated with a request or a previously received request. It is appreciated that the route from one location to another location may not be limited to two locations. When it is indicated that a route is devised between one location, A, and another location, B, it can be construed that there can be other locations, for example, C, in the route, at a point between A and B. Therefore, a route from A to B also can be understood as a route that connects locations A, C and B consecutively in a sequence (may be represented as “A→C→B”) which contains a route from A to C, followed by a route from C to B. In various embodiments, consecutive locations can be understood as locations that are connected consecutively in such sequence (e.g., A→C and C→B).

In another example, a route from a target pickup location of a request to a target destination location of the request may also comprise another route from a pickup location of a previously received request to a destination location of the previously received request.

Conventionally, when a plurality of requests are received, various possible routes connecting every two locations related to the multiple requests are devised to form a network of possible routes (or a graph network) and then such network of possible routes are then used to derive the optimal solution, for example, finding a best route (e.g., in terms of cost, distance and/or time) that connects all pickup locations to all destination locations to meet the multiple requests in a single trip. However, devising the possible routes according to the conventional approach requires computation of the expensive routing distances of all possible routes to derive the optimal solution. In the present disclosure, a route devising server is configured to determine whether to devise a route from one to another location of such multiple requests, for example through comparisons of distances of two pickup locations associated with the requests against a threshold value, and once it is determined that a route from one to another location is to be devised, the server is configured to devise such route to form the network. With less routes to compute, the present disclosure has an advantage of speeding up the determination of the optimal solution to fulfil multiple requests with reduced computational cost.

In one embodiment, the route devising server may devise all possible routes connecting every two locations related to the multiple requests to form a network of possible routes and then determine whether or not any of such routes is to be devised, and if it is determined that a route from one to another location is not to be devised, the server is configured to remove such route to the network of possible routes before it is used to derive the optimal solution that fulfil the multiple requests.

In a graph network, a point may be used to refer to a unique location indicated in a request while an edge is used to connect two points. A route from one location to another location according to the present disclosure may refer to an edge (or directed edge) in the graph network if the route connects only two points in the graph network (e.g., only a pickup location and a destination location indicated a request) or multiple edges if the route connects more than two points (e.g., two pickup locations and one destination location of indicated request; one pickup location and two destination locations indicated a request; or two pickup locations and two destination locations indicated in two requests); and devising a route from one location to another location can be construed as devising one or more edges connecting the points corresponding to the locations in the graph network accordingly For example, a route from a first location, A, to a second location, B, could contain multiple edges if there is a third location, C, in between A and B. Specifically, a route from A to B could comprise a first edge connecting A and C, and a second edge connecting C and B. In various embodiments below, a route from one location to another location is directional and therefore refers to one or more directed edge, where a directed edge corresponds to an edge that connects two locations in a specific direction (e.g., location A to location B) and not the opposite direction (e.g., from location B to A); and devising a route from one location to another location can be construed as devising one or more directed edges indicating the specific directions of connections of the points corresponding to the locations in the graph network accordingly. A directed edge from location A to location B may be represented as “A→B” using arrow “→” and a route comprising multiple edges from location A to location B and then from location B to location C may be represented as “A→B→C” accordingly.

Determining—The term “determining” can be understood broadly as to cause to occur in a particular way, or ascertain, or establish by calculation. More specifically, the term is used herein to determine a route or a distance connecting different target locations and locations related to a request and a previously received request respectively. For example, a distance between a target pickup location of a request and a pickup location of a previously received request can be determined. The determined distance can be compared with a threshold value to further determine if the determined distance is below the threshold value. Based on the determination, a server may determine whether or not to devise a route between the pickup location from the previously received request and a destination location from the previously received request. When it is determined that the route should be devised, the route may be devised by a server (e.g., a route devising server) and stored in a database. In various embodiments below, a route may be removed if it is determined that the route is not to be devised.

In another example, the term is also used to determine if there is an intersection between two determined routes. Based on the determination of the intersection, the server may devise a specific route between a target pickup location and a target destination location of a request. When it is determined that the specific route should be devised, the specific route may be devised by a server (e.g., a route devising server) and stored in a database.

Comparing—The term “comparing” refers to the act of evaluating two or more sets of data to identify their similarities and differences. This may include, for example, comparing distances between locations of a request or a previously received request. A server may use this comparison to determine if a route should be devised between locations relating to the request or the previously received request. The term may also include, for example, comparing a distance between two locations indicated in a request to determine whether the distance is within a threshold value.

Devising—The term “devising” can be understood as devising a route between locations related to a request or a previously received request. In various embodiments below, a route from one location to another location will be devised after a determination step. The phrase “devising a route” may mean adding, by a server, a route (directed edge(s)) connecting the locations indicated in the requests after it is determined that route can be added to form a network of possible routes. In an alternative embodiment, the phrase “devising a route” may mean adding all possible routes (edge(s)/directed edge(s)) to form a network of routes connecting all locations indicated in the request and, after determining not to devise a route), removing the route (edge/directed edge(s)) from the network of routes. In various embodiments, such addition and removal of a route is based on a determination that the route falls within a threshold value. In an example, when two distances between two different routes are compared, the route with the shorter distance is devised and may be stored in a database while the route with the longer distance is not added into the pool of existing routes, thereby disabling the route with the longer distance from being further analysed.

Threshold—The term threshold herein is used to indicate a reference value that is used to compare against a value associated or derived from the data of a request. In various embodiments below, such threshold may vary depending on the locations associated with a request. Examples of a threshold value in this present disclosure includes a threshold distance/value used to compare against the distance of a route between any two locations (e.g., two pickup locations) and the distance of a route connecting four locations (e.g., pickup locations and destination locations of two requests).

### DETAILED DESCRIPTION

### The System 100

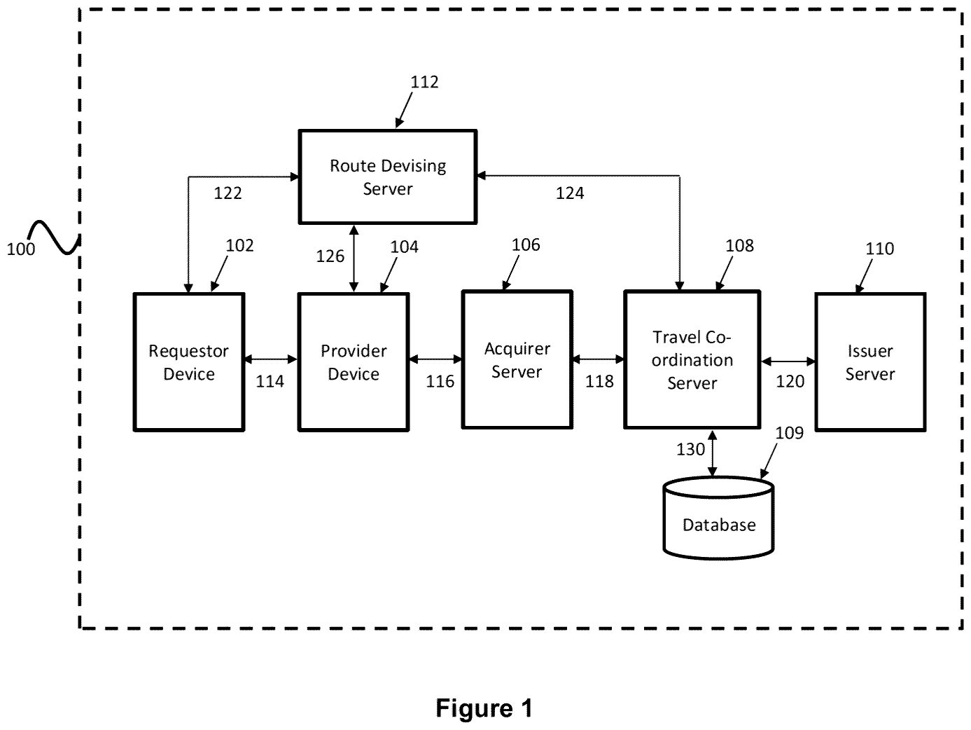

FIG. 1 shows a block diagram illustrating a system 100 for adaptively devising a route between locations associated with a request. Further, the system 100 enables a request and a payment transaction for a ride between a requestor and a provider.

The system 100 comprises a requestor device 102, a provider device 104, an acquirer server 106, a travel co-ordination server 108, an issuer server 110, a route devising server 112, a database 109.

The requestor device 102 is in communication with a provider device 104 via a connection 114. The connection 114 may be wireless (e.g. via NFC communication, Bluetooth, etc.) or over a network (e.g. the Internet). The requestor device 102 is also in communication with the route devising server 112 via a connection 122. The connection 122 may be a network (e.g. the Internet).

The provider device 104 is in communication with the requestor device 102 as described above. The provider device 104 is, in turn, in communication with an acquirer server 106 via a connection 114. The provider device 104 is also in communication with the route devising server 112 via a connection 126. The connections 116 and 126 may be a network (e.g. the Internet).

The acquirer server 106, in turn, is in communication with a travel co-ordination server 108 via a connection 118. The travel co-ordination server 108, in turn, is in communication with an issuer server 110 via a connection 120. The connections 118 and 120 may be a network (e.g. the Internet).

The travel co-ordination server 108 is further in communication with the route devising server 112 via a connection 124. The connection 124 may be over a network (e.g. a local area network, a wide area network, the Internet, etc.) In one arrangement, the travel co-ordination server 108 and the route devising server 112 are combined and the connection 124 may be an interconnected bus.

In the illustrative embodiment, each of the devices 102, 104; and the servers 106, 108, 110, and 112 provides an interface to enable communication with other connected devices 102, 104 and/or servers 106, 108, 110, 112. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCS) corresponding to interface elements, messaging interfaces in which the interface elements correspond to messages of a communication protocol, and/or suitable combinations thereof. For example, it is possible for at least one of the requestor device 102 to send a request to the travel co-ordination server 112 via a GUI so that the request can be matched to a provider with a provider device 104.

Use of the term ‘server’ herein can mean a single computing device or a plurality of interconnected computing devices which operate together to perform a particular function. That is, the server may be contained within a single hardware unit or be distributed among several or many different hardware units.

### The Route Devising Server 112

The route devising server 112 is associated with an entity (e.g. a company or organization or moderator of the service). In one arrangement, the route devising server 112 is owned and operated by the entity operating the travel co-ordination server 108. In such an arrangement, the route devising server 112 may be implemented as a part (e.g. a computer program module, a computing device, etc.) of the travel co-ordination server 108.

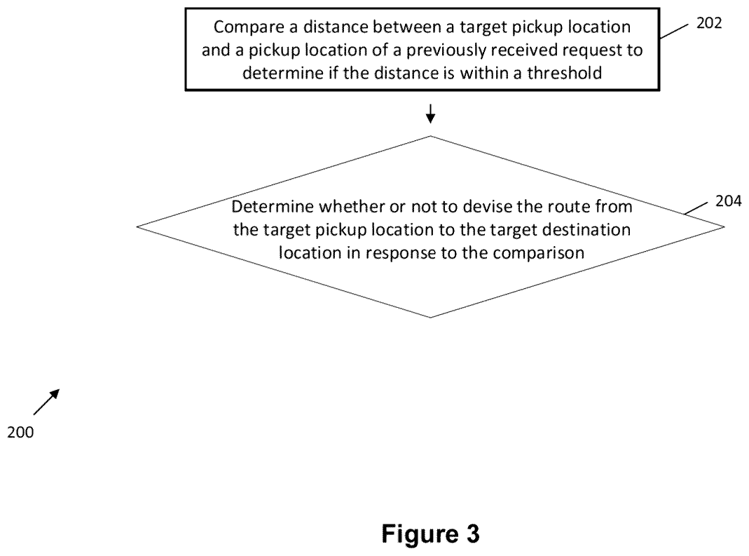

The route devising server 112 is a server that hosts route devising software application programs for adaptively devising a route between locations and perform the operations in FIG. 3. The route devising server may obtain data relating a request (e.g. pick up location, destination location), from a requestor device 102 or the travel co-ordination server 108, and use the data for adaptively devising a route between locations. The route devising server 112 devises the possible routes between the locations related to the requests and creates a pool of possible routes to be stored in the database 109.

The route devising server 112 is in connection with the requestor device 102, provider device 104 and travel co-ordination server 108 by connections 122, 126 and 124 respectively.

### The Requestor Device 102

The requestor device 102 is associated with a customer (or requestor) who is a party to a request that occurs between the requestor device 102 and the provider device 104. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 includes transaction credentials (e.g. a payment account) of a requestor to enable the requestor device 102 to be a party to a payment transaction.

### The Provider Device 104

The provider device 104 is associated with a provider who is also a party to the request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like.

Hereinafter, the term “provider” refers to a service provider and any third party associated with providing a travel, ride or delivery service via the provider device 104. In an example, the provider may receive a request from a requestor device 102 via the travel co-ordination server 108 to his provider device 104. Upon request, the provider (e.g., a driver) may be required to transport items, goods or person from a pickup location to a destination location.

### The Acquirer Server 106

The acquirer server 106 is associated with an acquirer who may be an entity (e.g. a company or organization) which issues (e.g. establishes, manages, administers) a payment account (e.g. a financial bank account) of a merchant (e.g. provider). An example of an acquirer is a bank or other financial institution. The acquirer server 106 may include one or more computing devices that are used to establish communication with another server (e.g. the travel co-ordination server 108) by exchanging messages with and/or passing information to the other server. The acquirer server 106 forwards the payment transaction relating to a request to the travel co-ordination server 112.

### The Travel Co-Ordination Server 108

The travel co-ordination server 108 is a server that hosts software application programs for processing requests or payment transactions. The travel co-ordination server 108 communicates with other servers (i.e., an acquirer server 106, an issuer server 110 or route devising server 112) to transmit a request or payment transactions related to a request. A travel co-ordination server is configured to carry out processes relating to a request, for example, forwarding data and information associated with the location of a requestor or a request to other servers in the system, such as the route devising server 112. In an example, the travel co-ordination server 108 may provide location data, vehicle data, route data associated with a request to be used by the route devising server 112. The travel co-ordination server 108 may be configured to communicate with, or may include, a database 109 via connection. The connection may be over a network (e.g. a local area network, a wide area network, the Internet, etc.).

The travel co-ordination server is usually managed by a service provider that may be an entity (e.g. a company or organization) which operates to handle requests, such as pairing a request to a provider. The travel co-ordination server may include one or more computing devices that are used for processing requests.

### The Database 109

The database 109 stores data relating to locations, routes and vehicles. The database may be a component of the travel co-ordination server 108. In an example, the database may be a database managed by an external entity and the database 109 is a server that, based on a request received from a device (such as the requestor device 102 or the provider device 104) or the travel co-ordination server 108, retrieve locational data associated with a request and transmit the data to the user device or the travel co-ordination server 108. The database 109 also stores a pool of existing routes connecting the different locations of previously received requests.

### The Issuer Server 110

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the user. The issuer server 110 may include one or more computing devices that are used to establish communication with another server (e.g. the travel co-ordination server 108 by exchanging messages with and/or passing information to the other server.

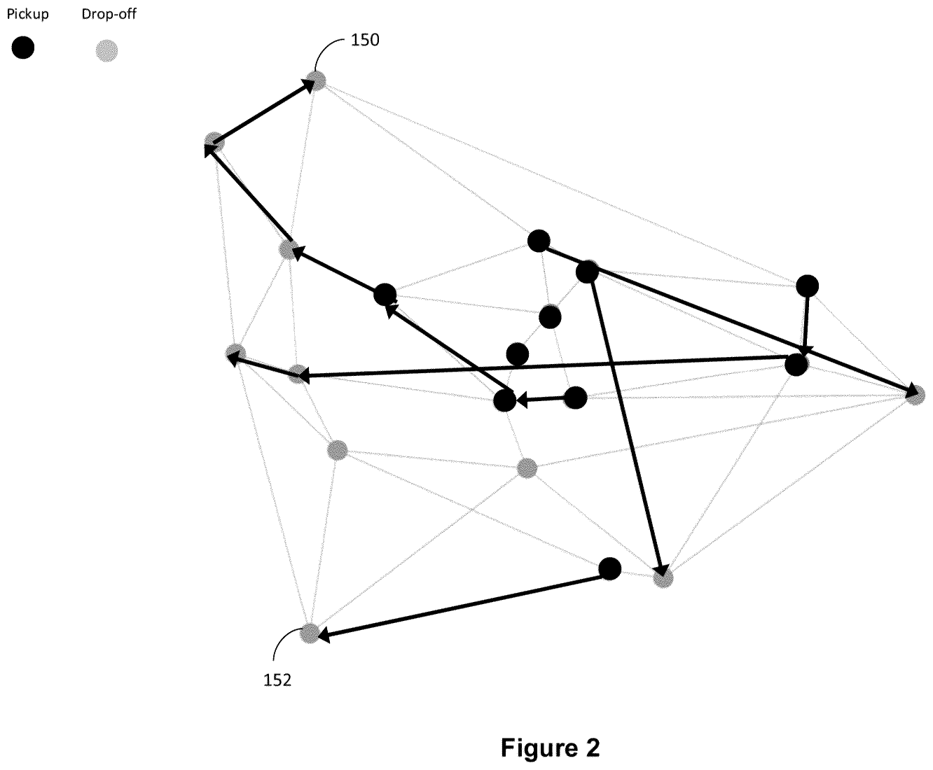

FIG. 2 shows a graph network connected by multiple locations associated with multiple requests according to an embodiment of the present disclosure, where each point corresponds to a unique location associated with a request and each edge connects two unique locations.

One difference between the present disclosure and other techniques is that the conventional approach requires computing the expensive routing distance of a graph edge first, and then removing the edge, if necessary. Typically, no steps are taken to reduce the efforts in constructing the input (edges). The embodiments of this disclosure aim to speed up the computation of edges by reducing the input (edges) to achieve the graph of points (pickup or drop-off) and edges (or directed edges) as observable in FIG. 2. Specifically, the conventional technique requires all edges to be generated between point 150 and point 152 of the graphical network shown in FIG. 2. However, the present disclosure introduces a step of determining whether or not to generate a route between the two points, and the route devising server 112 may not devise an edge that connects between two points if it determines that the distance between the two points may not meet the requirements as elaborated in various embodiments below.

For each pair of requests:

If a target pickup location and a pickup location are close to each other (the closeness of the pickup locations defined by a first threshold value which will be elaborated in further embodiments), the route devising server 112 may remove an edge from a destination location to the target pickup location when is determined that the distance between the target pickup location and a destination location is larger than the distance between the target destination location and the target pickup location.

In one example, a pickup location of a request should be visited first before a destination location indicated in the request. Batching two requests may result in six possible permutations of routes, such that the routes connect at least two pickup locations and two destination locations related to the requests. For example, each permutation of locations related to a request and a previously received request may be a route connecting the target pickup location, the target destination location, the pickup location and the destination location in a different sequence. The six permutations of routes may be compared against a second threshold value, and specific edges may be removed based on the result of the comparison. Additionally, it is to be understood that the distance between a pickup location and the pickup location of a same request is always equal to zero.

Advantageously, this may sparsify the graph network. In an embodiment, the route devising server 112 will remove edges/routes between pickup locations and destination locations related to requests by determining whether or not the edges/routes should be devised. The conditions for determination of the devising may vary depending on various conditions. These conditions, for example, could be comparing the distance of the edge/s routes with other edges/routes, determining whether the distance of the edges/routes is lower than a threshold value, or whether the edges/routes intersect. The result of determination by the route devising server 112 is a graph network with less edges/routes than a graph network obtained from conventional techniques. Additionally, the route devising server 112 may evaluate the sparsified graph network by computing the graph network's optimality gap, wherein optimality gap is defined by how accurate the devised routes between pickup locations and destination locations of location are compared to the exact optimal solution computed by the conventional technique. Numerical experiments show that the two proposed high level approaches above may increase the routing matrix sparsity from 1.24% to 39% for express delivery service, and reduce solution optimality gap by 0.036% pp. This translates to a graph network with fewer edges that has 0.036% pp gap with the optimal graph network obtained from conventional techniques, resulting in a close-to-optimal graphical network with lower inputs (edges) to compute.

Embodiments related to the two graph sparsification heuristics will be further elaborated below.

FIG. 3 shows the flow charts of method 200 of adaptively devising a route from a target pickup location to a target destination location using the system 100.

The method 200 commences at step 202 (see FIG. 3) by the route devising server 112 comparing a distance between a target pickup location of a request and a pickup location of a previously received request to determine if the distance is below a threshold. The information related to the location and distance is retrieved from the database 109 by the travel co-ordination server 108 and transmitted to the route devising server 112. The method 200 then proceeds from step 202 to 204.

In step 204, the route devising server 112 determines whether or not to devise the route from the target pickup location to the target destination location in response to the comparison of step 202. If route has been devised, the travel co-ordination server 108 transmits the route data to be stored in database 109.

The following conditions may be required when carrying out the steps of method 200:
Each request may comprise at least one pickup location and one destination location.
Each request's locations should not have been visited prior to the steps of method 200.

Prior to step 202 of method 200, the route devising server 112 may retrieve the following data from the travel coordination server 108:
Geographical data relating to pickup locations and destination locations of requests or previously received requests (e.g., latitude and longitude data of the locations)
The distance between the locations related to a request or a previously received request. (e.g., routing distance between a target pickup location and a target destination location of a request)

In an embodiment, the distance between the locations related to a request or a previously received request may be a routing distance. A routing distance refers to the total length between two locations, including all the curves and paths along a route connecting the two locations, as they would be encountered in real-world travel situations.

Such routing distance may be used subsequently to determine the optimal solution to fulfil multiple requests, as will be elaborated further in the embodiments below.

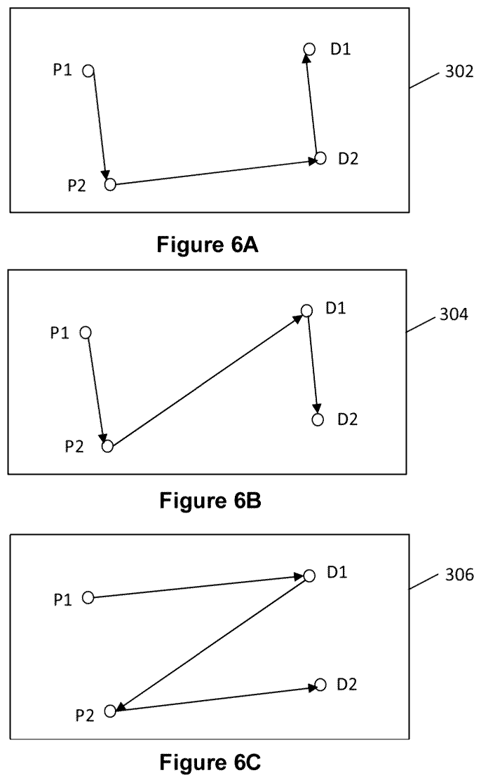

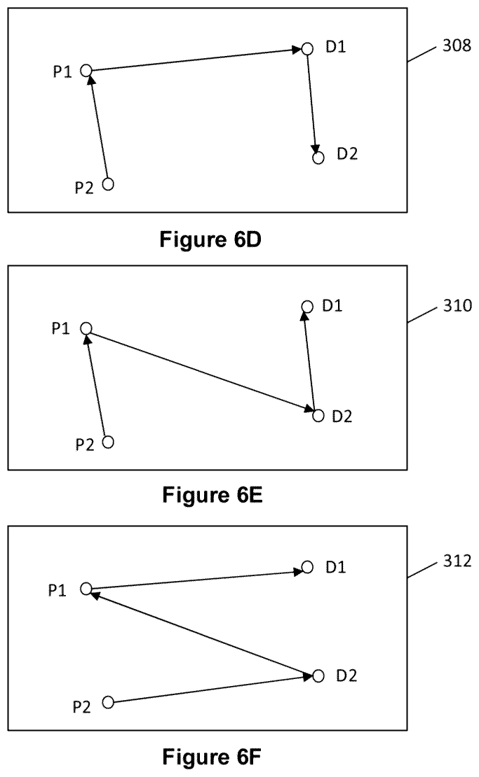

In an embodiment, the route devising server 112 retrieves the data of a request and a previously received request from the database 109 via the travel co-ordination server 108. The identifiable locations are pickup location, P1, destination location, D1, target pickup location, P2, and target destination location, D2, as indicated in FIGS. 6A-6F. If P1 and P2 are close (step 202, wherein closeness is defined by a first threshold) to each other, the distance between P1 to D1 is compared with the distance between P1 and D2. After the comparison, the route devising server determines to devise the route that has a shorter distance from the pickup location to the destination location and not to devise the route that has a longer distance. For example, if it is determined that the distance between P1 and D2 is greater than the distance between P1 and D1, the route devising server will devise the route from P1 to D1 and add the devised route into the pool of routes in the database 109 by the travel co-ordination server 108 (step 204). The route that has a longer distance from the pickup location to the destination location, as identified by the route devising server 112, will be determined by the route devising server 112 that the longer route will not be devised, for example, to remove the route if it is in the pool of routes in the database 109.

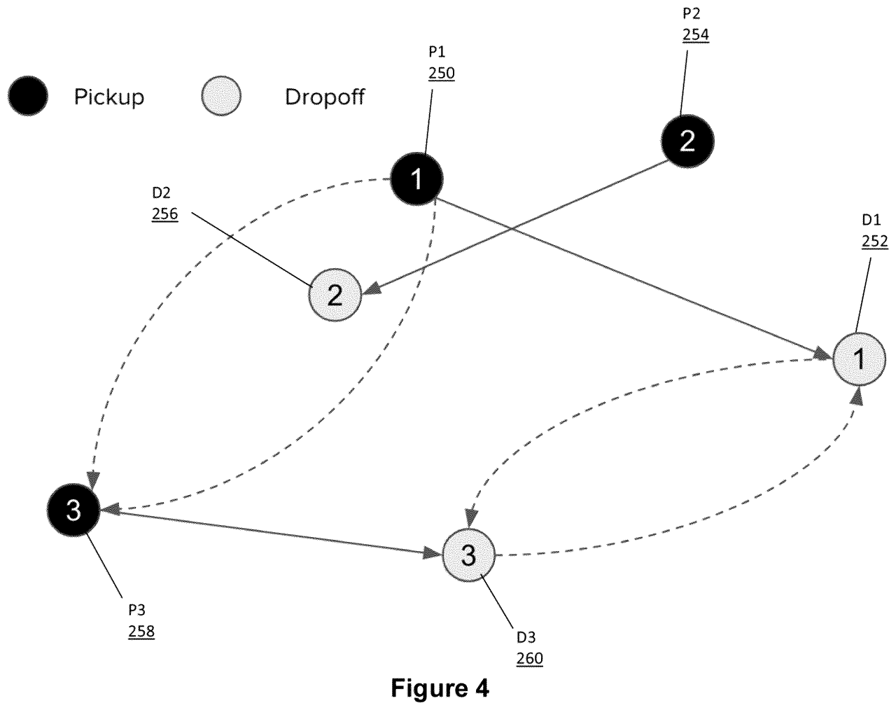

FIG. 4 shows a geographical map comprising locations related to three requests each having a pickup location and a destination location according to an embodiment of the present disclosure.

In this example, the locations related to the three requests are represented by the following:
1. a first pickup location, P1 250, and a first destination location, D1 252, of a first request;
2. a second pickup location, P2 254, and a second destination location, D2 256, of a second request (e.g., previously received request); and
3. a third pickup location, P3 258, and a third destination location, D3 260 of a third request (e.g., another previously received request).

When two pickup locations, such as P1 250 and P2 254, are close to each other, the route devising server 112 may determine the closeness of P1 250 and P2 254 by comparing the distance between P1 250 and P2 254 against a first threshold value. In this embodiment, the first threshold value for comparing the closeness of P1 250 and P2 254 is given by the summation of (i) the distance between D2 256 and P1 250 and (ii) the distance between P2 254 and D2 256. When it is determined that the distance is below the first threshold value, the route devising server may determine the destination location that is furthest away from the two pickup locations. In this example, the route devising server 112 determines that D3 260 is the furthest destination location from P2 254 and further determines not to devise a route from D3 260 to P2 254. This can be observed in the absence of edges between D3 260 and P2 254 in FIG. 4.

In one embodiment, the route devising server 112 carries out the steps of method 200 in the following manner:
If D2→P1+P→D2>ratio1*(P1→P2), the route D2→P1 is removed.

The arrow sign “→” should be understood as a directed edge from one location to another location. P1 and D1 corresponds to a pickup location and a destination location of a first request, while P2 and D2 corresponds to a pickup location and a destination location of a second request (e.g., previously received request).

If it is determined that a sum of the distance between D2 and P1 and the distance between P2 and D2 is larger than a distance between P1 and P2 multiplied by a weightage (e.g., ratio1), the route devising server 112 will determine not to devise a directed edge from D2 to P1. In this example, the sum of the distance between D2 and P1 and the distance between P2 and D2 serves as a first threshold value when comparing the “closeness” of P1 and P2. Vice versa, if it is determined that the sum of the distance between D2 and P1 and the distance between P2 and D2 falls below the weighted distance between P1 and P2, the route devising server 112 determines to devise the directed edge from D2 to P1. The routing time for travelling the distance between P1 and D1 and the distance between P2 and D2 may also be computed.

The ratio1 from the above embodiment can be calculated by equation (1) as follows:

$$equation ( 1 )$$

$$ratio 1 = straight - line distance ( D 2 , P 1 ) + \frac{routing distance ( P 2 , D 2 )}{straight - line distance ( P 2 , D 2 )} .$$

It is to be understood that a straight-line distance between two locations may be the shortest distance between the two locations.

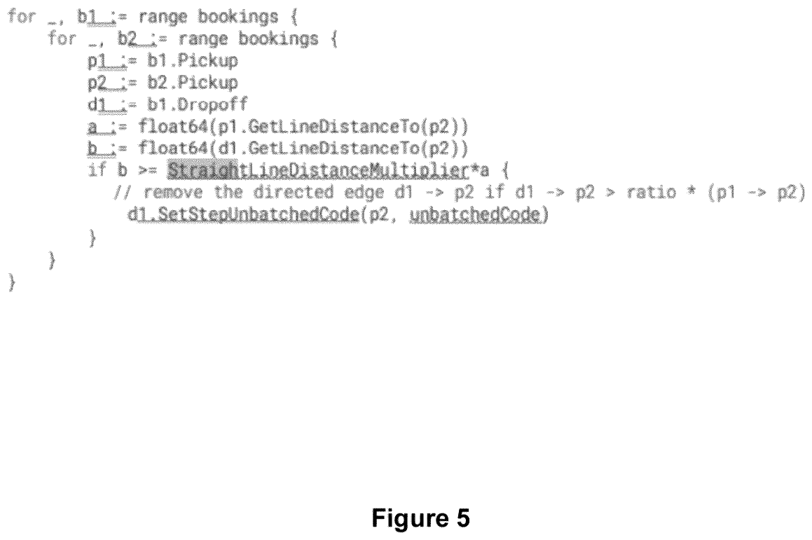

The above embodiment, when executed with a programming language, corresponds to the code snippet provided in FIG. 5.

In one embodiment, the route devising server 112 retrieves data relating to locations of two requests from database 109 via the travel co-ordination server 108. The two requests each have a pickup location and a destination location according to an embodiment of the present disclosure. The pickup locations and destination locations of the two requests may be referred to as P1, D1, P2 and D2, wherein P1 and D1 may be associated with the first request while P2 and D2 may associated with the second request (e.g., previously received request). With the locational data, and assuming a pickup location of a request should be visited first before a destination location indicated the request, the route devising server 112 determines a total of 6 possible permutations of routes connecting the four locations as can be seen from routes 302, 304, 306, 308, 310 and 312 from FIGS. 6A-6F.

In particular, route 302 connects the four locations in a sequence (P1→P2→D2→D1) with three edges, and correspond to a route having a first edge P1 to P2, a second edge from P2 to D2 and a third edge from D2 to D1; whereas route 304 connects the four locations in another sequence (P1→P2→D1→D2). In an example, P1 and D1 corresponds to a pickup location and a destination location of a previously received request, while P2 and D2 corresponds to a target pickup location and a target destination location of a request. Therefore, routes 302 to 312 can be understood as routes that connect the target pickup location, the target destination location, the pickup location and the destination location in a sequence. The trip distance of the routes can be computed by adding the distance of each edge, such as the distance between two consecutive locations in the sequence, until the final location. For example, the trip distances of route 302 can be computed by adding the distance of the first edge (first distance) between P1 and P2, the distance of the second edge (second distance) between P2 and D2 and the distance of the third edge (third distance) between D2 and D1. The trip distances of the routes in 304-312 can also be calculated in the same manner as that used for calculating the trip distance of route 302.

Therefore, the trip distances, S1-S6, of the routes 302-312 correspond to below:

$$S 1 = P 1 \to P 2 + P 2 \to D 2 + D 2 \to D 1$$

$$S 2 = P 1 \to P 2 + P 2 \to D 1 + D 1 \to D 2$$

$$S 3 = P 1 \to D 1 + D 1 \to P 2 + P 2 \to D 2$$

$$S 4 = P 2 \to P 1 + P 1 \to D 2 + D 1 \to D 2$$

$$S 5 = P 2 \to P 1 + P 1 \to D 2 + D 2 \to D 1$$

$$S 6 = P 2 \to D 2 + D 2 \to P 1 + P 1 \to D 1$$

The trip distances of S1-S6 may comprise routing distances of routes going from one location to another, straight-line distances of routes going from one location to another, or a mixture of both. For example, S1 may comprise a straight-line distance between P1 and P2, a routing distance between P2 and D2 and a straight-line distance between D2 and D1. Route devising server 112 is programmed to utilize the routing distances of the routes when computing trip distances S1-S6 whenever routing distance is available. Otherwise, straight-line distances of the routes will be used instead. It is to be understood that the straight-line distance between any two locations is always shorter or equal to the routing distance between the two locations.

In an embodiment, the server is further configured to determine whether a routing distance between two locations is available, and if it is not available the server will then calculate the distance between the two locations using a straight-line distance of the two locations. In one embodiment, routing distances are calculated by straight-line distance multiplied by a Straight-line Distance Multiplier. A suggested value for Straight-line Distance Multiplier is 1.5.

In one embodiment, a second threshold value, X, which is the total unbatched trip distance, is computed to determine whether the trip distances of batched trips (S1-S6) exceeds the total unbatched trip distance. X can be computed using equation (2), as follows:

$$X = routing distance ( P 1 , D 1 ) + routing distance ( P 2 , D 2 ) . \qquad equation ( 2 )$$

In an embodiment, the route devising server 112 performs the following steps:
If S1 *Minimum Distance Efficiency>X and S2 *Minimum Distance Efficiency>X, remove the directed edge from P1 to P2.
If S4 *Minimum Distance Efficiency>X and S5 *Minimum Distance Efficiency>X, remove the directed edge from P2 to P1.
If S2 *Minimum Distance Efficiency>X and S4 *Minimum Distance Efficiency>X, remove the directed edge from D1 to D2.
If S1 *Minimum Distance Efficiency>X and S5 *Minimum Distance Efficiency>X, remove the directed edge from D2 to D1.

More specifically, in step 1, if it is determined that the trip distance, S1, of route 302 multiplied by a weightage (Minimum Distance Efficiency) is greater than the second threshold value X, and the trip distance, S2, of route 304 multiplied by a weightage (Minimum Distance Efficiency) is also greater than X, the route devising server 112 determines to remove the directed edge between two consecutive locations, P1 to P2.

The Minimum Distance Efficiency from the above embodiment can be computed using equation (3), as follows:

$$Minimum Distance Efficiency = \frac{X}{trip distance} . \qquad equation ( 3 )$$

A suggested value for Minimum Distance Efficiency is 1.

In an embodiment, the Minimum Distance Efficiency serves as a weightage that can be multiplied to the trip distances S1-S6 prior to determining if the trip distance exceeds the second threshold, X.

In another embodiment, if a minimum trip distance between S1, S2, S4 or S5 multiplied by a Minimum Distance Efficiency is larger than X, the route devising server 112 removes the following edges:
The directed edge from P1 to D2
The directed edge from D1 to D2
The directed edge from P2 to D1
The directed edge from D2 to D1

More specifically, the route devising server 112 compares a plurality of trip distances, S1, S2, S4 and S5 to determine the trip distance that has shortest trip distance, If, for example, S1 of route 302 is determined to have the shortest trip distance, S1 will be multiplied by a weightage (Minimum Distance Efficiency) and compared against the second threshold value, X. When it is determined by the route devising server 112 that the calculated value exceeds the second threshold value, the route devising server will determine to remove the four directed edges concerning two consecutive locations (e.g., directed edge from D1 to D2) as mentioned in items 1-4 of the above embodiment.

Additionally, if the route from P1 to D1 and the route from P2 to D2 intersect, route devising server 112 removes the following edges:
The directed edge from D1 to P2
The directed edge from D2 to P1

Specifically, if route devising server 112 determines that there is an intersection between the route from P1 to D1 and the route from P2 to D2, the route devising server 112 determines to remove the directed edge from D1 to P2 and the directed edge from D2 to P1. For example, when route devising server 112 determines that a route from a pickup location to a destination location intersect with a route from a target pickup location to a target destination location, the route devising server 112 may determine to remove the directed edge from the destination location to the target pickup location and the route from the target destination location to the target pickup location.

### Structural Context

### The Route Devising Server 112

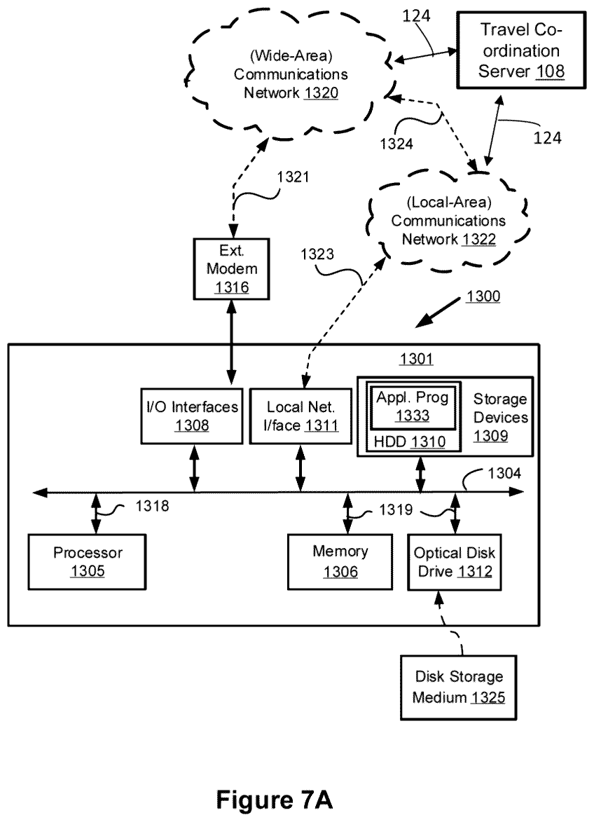

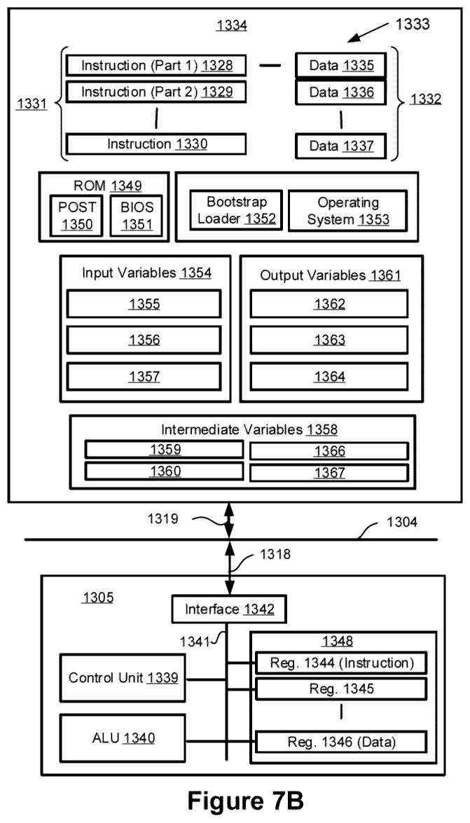

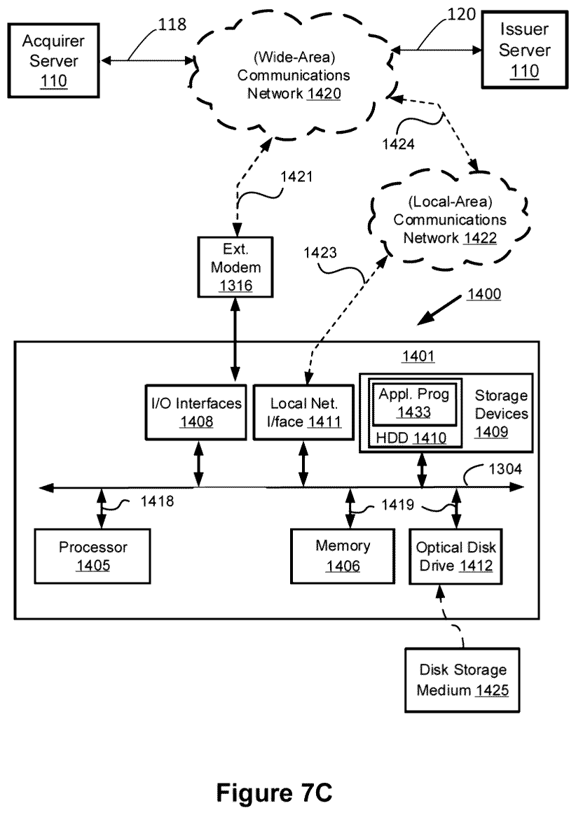

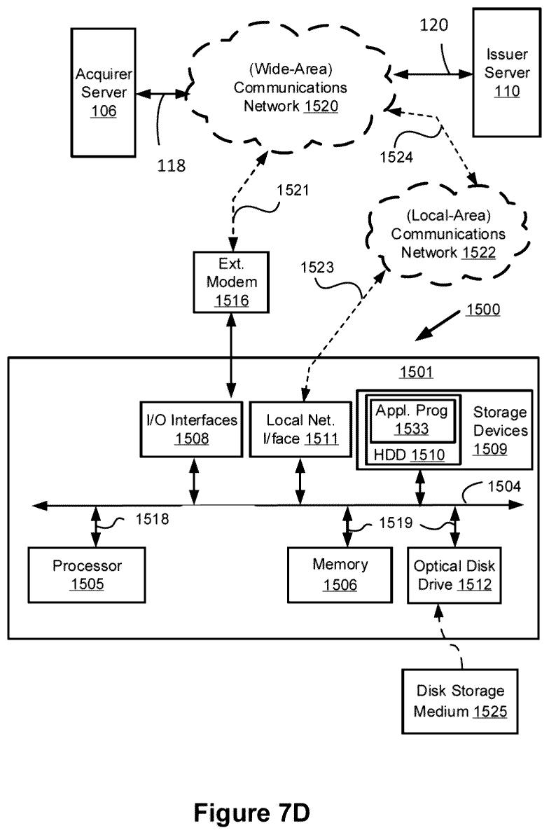

FIGS. 7A and 7B depict a general-purpose computer system 1300, upon which the route devising server 112 described can be practiced.

As seen in FIG. 7A, the computer system 1300 includes a computer module 1301. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an interface 1308 for the external modem 1316. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 7A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement; however, numerous other types of interfaces may be practiced for the interface 1311.

The I/O interfaces 1308 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks, USB-RAM, portable, external hard drives, and floppy disks, for example, may be used as appropriate sources of data to the system 1300.

The components 1305 to 1312 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple or like computer systems.

The steps of the method 200 in FIG. 3, performed by the route devising server 112 may be implemented using the computer system 1300. The steps of the method 200 may be implemented as one or more software application programs 1333 executable within the computer system 1300. In particular, the steps of the method 200 as performed by the route devising server 112 are effected by instructions 1331 (see FIG. 7B) in the software 1333 that are carried out within the computer system 1300. The software instructions 1331 may be formed as one or more code modules, each for performing one or more particular tasks. The software may also be divided into two separate parts, in which a first part and the corresponding code modules performs the steps of the route devising server 112 and a second part and the corresponding code modules manage a user interface between the first part and the user.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 preferably effects an advantageous apparatus for a route devising server 112.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for a route devising server 112.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, optical disk, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon a display. Through manipulation of typically a keyboard and a mouse, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

FIG. 7B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 7A.

When the computer module 1301 is initially powered up, a power-on self-test (POST) program 1350 executes. The POST program 1350 is typically stored in a ROM 1349 of the semiconductor memory 1306 of FIG. 16A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 7A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 7A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 7B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 7A. The execution of a set of the instructions may in some cases result in output of data. Execution may also involve storing data or variables to the memory 1334.

The disclosed route devising server 112 arrangements use input variables 1354, which are stored in the memory 1334 in corresponding memory locations 1355, 1356, 1357. The route devising server 112 arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 7B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:
a fetch operation, which fetches or reads an instruction 1331 from a memory location 1328, 1329, 1330;
a decode operation in which the control unit 1339 determines which instruction has been fetched; and
an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step in the method 200 of FIG. 3, as performed by the route devising server 112, is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

It is to be understood that the structural context of the computer system 1300 (i.e., the route devising server 112) is presented merely by way of example. Therefore, in some arrangements, one or more features of the server 1300 may be omitted. Also, in some arrangements, one or more features of the server 1300 may be combined together. Additionally, in some arrangements, one or more features of the server 1300 may be split into one or more component parts.

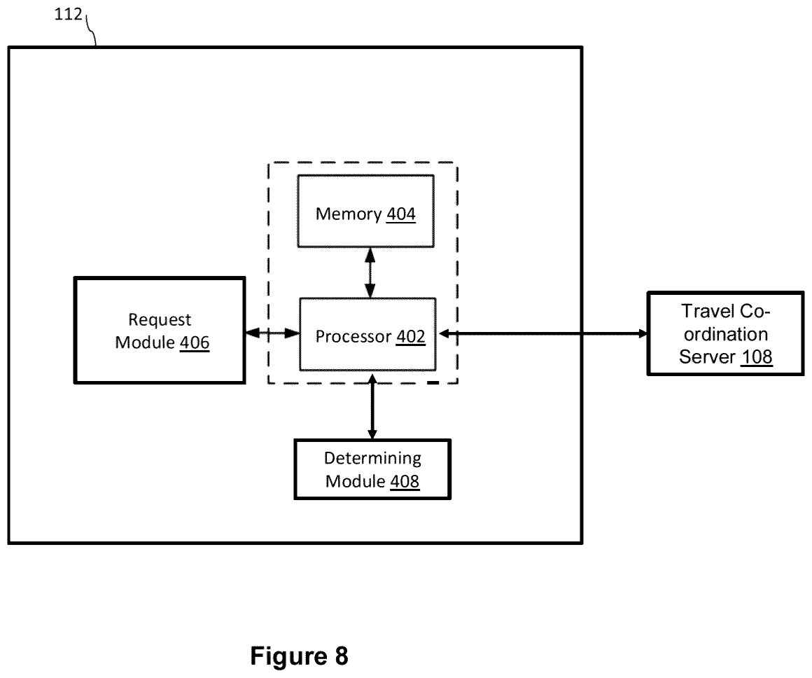

FIG. 8 shows an alternative implementation of the route devising server 112 (i.e., the computer system 1300). In the alternative implementation, route devising server 112 may be generally described as a physical device comprising at least one processor 402 and at least one memory 404 including computer program codes. The at least one memory 404 and the computer program codes are configured to, with the at least one processor 402, cause the route devising server 112 to perform the operations described in the method 200. The route devising server 112 may also include a request module 406, a determining module 408. The memory 404 stores computer program code that the processor 502 compiles to have modules 406 and 408 to perform their respective functions.

With reference to FIG. 1, the request module 406 performs the function of communicating with the travel co-ordination server 108 to receive requests, such as requests to transport a requestor from a pickup location to a destination location.

The determining module 408 performs the function of determining whether or not a route should be devised in between locations related to a request as described in step 204 of the method 200.

### The Travel Co-Ordination Server 108

FIG. 7C depict a general-purpose computer system 1400, upon which the travel coordination server 108 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also Includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 7C, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of Interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1404 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 200 in FIG. 3, where performed by the travel coordination server 108 may be implemented using the computer system 1400. The processes may be implemented as one or more software application programs 1433 executable within the computer system 1400. In particular, the sub-processes 206 and 208 are effected by instructions (see corresponding component 1331 in FIG. 7B) in the software 1433 that are carried out within the computer system 1400. The software instructions may be formed as one or more code modules, each for performing one or more particular tasks. The software may also be divided into two separate parts, in which a first part and the corresponding code modules performs the methods and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A. computer readable medium having such software or computer program recorded on the computer readable medium is a computer program product. The use of the computer program product in the computer system 1400 preferably effects an advantageous apparatus for a travel co-ordination server 108.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a travel co-ordination server.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the travel co-ordination server 108) is presented merely by way of example. Therefore, in some arrangements, one or more features of the server 1400 may be omitted. Also, in some arrangements, one or more features of the server 1400 may be combined together. Additionally, in some arrangements, one or more features of the server 1400 may be split into one or more component parts.

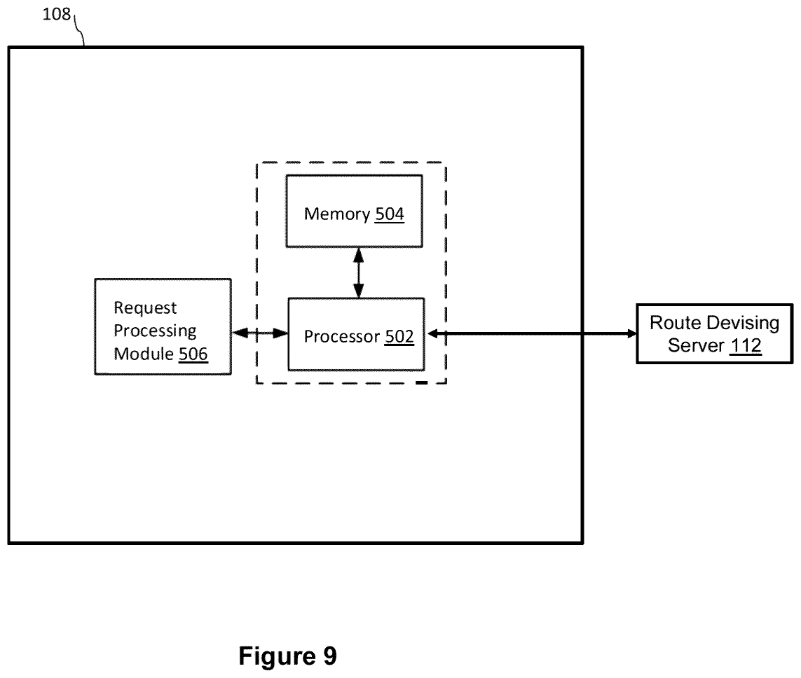

FIG. 9 shows an alternative implementation of the travel co-ordination server 108 (Le., the computer system 1400). In the alternative implementation, the travel co-ordination server 108 may be generally described as a physical device comprising at least one processor 502 and at least one memory 504 including computer program codes. The at least one memory 504 and the computer program codes are configured to, with the at least one processor 502, cause the travel co-ordination server 108 to perform the operations described in the method 200. The travel co-ordination server 108 may also include a transaction request processing module 506. The memory 504 stores computer program code that the processor 502 compiles to have modules 506 perform its functions.

With reference to FIGS. 1 and 2, the request processing module 506 performs the function of communicating with the requestor device 102 and the provider device 104; and the acquirer server 106 and the issuer server 110 to respectively receive and transmit a request message.

### The Combined Travel Co-Ordination Server 108 and Route Devising Server 112

FIG. 7D depict a general-purpose computer system 1500, upon which a combined travel co-ordination server 108 and route devising server 112 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 7D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity. the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an Interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 200 in FIG. 3, performed by the travel co-ordination server 108 and the route devising server 112 may be implemented using the computer system 1500. The steps 202 and 214 of method 200 as performed by the travel co-ordination server 108 may be implemented as one or more software application programs 1533 executable within the computer system 1500. In particular, the steps of the method 200 are effected by instructions (see corresponding component 1331 in FIG. 7B) in the software 1533 that are carried out within the computer system 1500. The software instructions may be formed as one or more code modules, each for performing one or more particular tasks. The software may also be divided into two separate parts, in which a first part and the corresponding code modules performs the steps of the methods 200 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined travel co-ordination server 108 and route devising server 112.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined travel co-ordination server 108 and route devising server 112.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user Interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (I.e., the route devising server 112) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

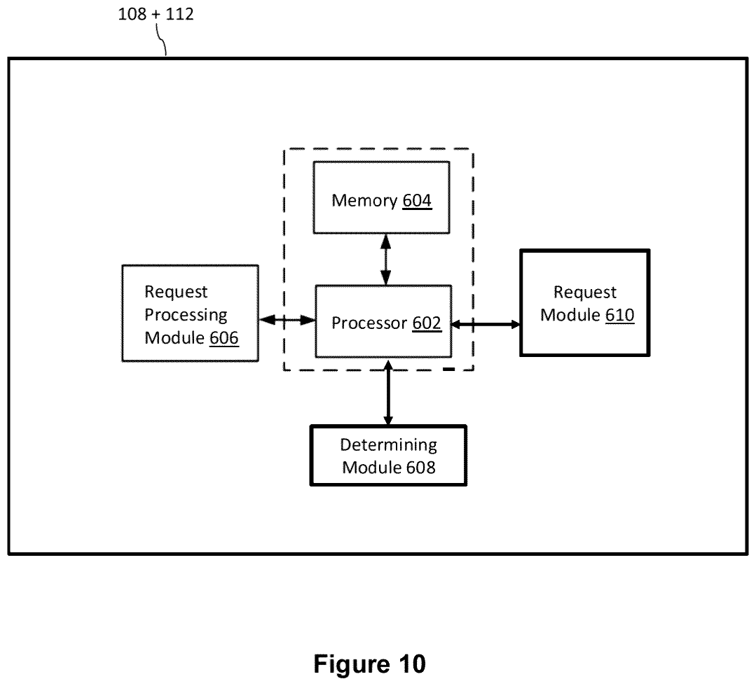

FIG. 10 shows an alternative implementation of the combined travel co-ordination server 108 and route devising server 112 (i.e., the computer system 1500). In the alternative implementation, the combined travel co-ordination server 108 and route devising server 112 may be generally described as a physical device comprising at least one processor 602 and at least one memory 604 including computer program codes. The at least one memory 604 and the computer program codes are configured to, with the at least one processor 602, cause the combined travel co-ordination server 108 and route devising server 112 to perform the operations described in the steps of the method 200. The combined travel co-ordination server 108 and route devising server 112 may also include a request processing module 606, a determining module 608, and a request module 610. The memory 604 stores computer program code that the processor 602 compiles to have each of the modules 606 to 610, perform their respective functions.

With reference to FIG. 1 the request processing module 606 performs the function of communicating with the requestor device 102 and the provider device 104; and the acquirer server 106 and the issuer server 110 to respectively receive and transmit a request message.

With reference to FIG. 1, the determining module 608 performs the function of determining whether or not a route should be devised in between locations related to a request as described in step 204 of the method 200.

With reference to FIG. 1, the request module 610 performs the function of communicating with the travel co-ordination server 108 to receive requests, such as requests to deliver goods from a pickup location to a destination location.

What is claimed is:

1. A method of adaptively devising a route from a target pickup location to a target destination location, the target pickup location and target destination location indicated in a request, comprising:
comparing, by a processor, a first distance between the target pickup location and a pickup location indicated in a previously received request to determine if the first distance is below a first threshold value; and
determining, by the processor, whether or not to devise the route from the target pickup location to the target destination location in response to the comparison.

2. The method, according to claim 1, further comprising:
calculating, by the processor, the first threshold value from a second distance between the target pickup location and the target destination location and a third distance between the target destination location and the pickup up location.

3. The method, according to claim 1, wherein the step of determining whether or not to devise the route between the target pickup location and the target destination location in response to the comparison further comprises:
determining, by the processor, whether or not to devise the route comprising a first route from the target destination location to the pickup location.

4. The method according to claim 1, further comprising:
multiplying the first distance by a weightage prior to determining if the first distance is below the first threshold value.

5. The method, according to claim 1, further comprising:
calculating, by the processor, a second threshold value from a fourth distance between the pickup location and the destination location and the first distance;
determining, by the processor, whether a fifth distance of a second route connecting the target pickup location, and the target destination location, the pickup location and the destination location in a sequence is below a second threshold value; and
determining, by the processor, whether or not to devise the route comprising a third route from one location to another location of consecutive locations in the sequence.

6. The method according to claim 5, further comprising:
calculating, by the processor, the fifth distance from a straight-line distance between two consecutive locations in the sequence, wherein the straight-line distance corresponds to a shortest distance between the two consecutive locations in the sequence.

7. The method according to claim 6, further comprising:
determining, by the processor, whether a distance between the two consecutive locations in the sequence is available, wherein the step of calculating the fifth distance from the straight-line distance is carried out in response to determining that the distance between the two consecutive locations in the sequence is not available.

8. The method according to claim 5, further comprising multiplying the fifth distance of the route by a weightage prior to determining if the second distance of the second route is below the second threshold value.

9. The method of claim 6, wherein the second route is one of a plurality of second routes, each of the plurality of second routes connecting the pickup location and the target destination location, the pickup location and the destination location in a different sequence, the method further comprising:
comparing, by the processor, second distances of the plurality of second routes; and
determining, by the processor, the second distance of the second route as having a minimum second distance among the second distances.

10. The method according to claim 1, wherein the step of determining whether or not to devise the route from the target pickup location to the target destination location in response to the comparison further comprises:
determining, by the processor, whether a fourth route from the pickup location to the destination location and the first route from the target pickup location to the target destination location intersect; and
further determining, by the processor, whether or not to devise the route comprising a fifth route from the destination location to the target pickup location in response to a result of the determination of the intersection.

11. The method according to claim 1, further comprising:
devising, by the processor, the route between the target pickup location and the target destination location in response to a result of the determination of whether or not to devise the route.

12. A system for adaptively devising a route from a target pickup location to a target destination location, the target pickup location and target destination location indicated in a request, comprising:
at least one processor; and
at least one memory including computer program code:
the at least one memory and the computer program code configured to, with the at least one processor, cause the system at least to:
compare a first distance between the target pickup location and a pickup location indicated in a previously received request to determine if the first distance is below a first threshold value; and
determine whether or not to devise the route from the target pickup location to the target destination location in response to the comparison.

13. The system of claim 12, wherein the at least one memory and the computer program code configured to, with the at least one processor, cause the system at least to further:
calculate the first threshold value from a second distance between the target pickup location and the target destination location and the third distance between the target destination location and the pickup location.

14. The system of claim 12, wherein the at least one memory and the computer program code configured to, with the at least one processor, cause the system at least to further:
determine whether or not to devise the route comprising a first route from the target destination location to the pickup location.

15. The system according to claim 12, wherein the at least one memory and the computer program configured to, with the at least one processor, cause the system at least to further:
multiply the first distance by a weightage prior to determining if the first distance is below the first threshold value.

16. The system according to claim 12, wherein the at least one memory and the computer program configured to, with the at least one processor, cause the system at least to further:
calculate a second threshold value from a fourth distance between the pickup location and the destination location and the first distance;
determine whether a fifth distance of a second route connecting the target pickup location, and the target destination location, the pickup location and the destination location in a sequence is below a second threshold value; and
determine whether or not to devise the route comprising a third route from one location to another location of consecutive locations in the sequence.

17. The system of claim 16, wherein the at least one memory and the computer program configured to, with the at least one processor, cause the system at least to further:
calculate the fifth distance from a straight-line distance between two consecutive locations in the sequence, wherein the straight-line distance corresponds to a shortest distance between the two consecutive locations in the sequence.

18. The system of claim 17, wherein the at least one memory and the computer program configured to, with the at least one processor, cause the system at least to further:
determine whether a distance between the two consecutive locations in the sequence is available, wherein the step of calculating the fifth distance from the straight-line distance is carried out in response to determining that the distance between the two consecutive locations in the sequence is not available.

19. The system according to claim 16, wherein the at least one memory and the computer program configured to, with the at least one processor, cause the system at least to further:
multiply the fifth distance of the route by a weightage prior to determining if the distance of the route is below the second threshold value.

20. The system of claim 17, wherein the at least one memory and the computer program configured to, with the at least one processor, cause the system at least to further:
determine the second route is one of a plurality of second routes, each of the plurality of second routes connecting the pickup location and the target destination location, the pickup location and the destination location in a different sequence;
compare second distances of the plurality of second routes; and
determine the second distance of the second route as having a minimum second distance among the second distances.

21. The system according to claim 12, wherein the at least one memory and the computer program configured to, with the at least one processor, cause the system at least to further:
determine whether a fourth route from the pickup location to the destination location and the first route from the target pickup location and to target destination location intersect; and
further determine whether or not to devise the route comprising a fifth route from the destination location to the target pickup location in response to a result of the determination of the intersection.

22. The system according to claim 12, wherein the at least one memory and the computer program configured to, with the at least one processor, cause the system at least to further:
devise the route between the target pickup location and the target destination location in response to a result of the determination of whether or not to devise the route.
